(19) United States
(12) Patent Application Publication
(10) Pub. No.: US 2004/0123110 A1
(43) Pub. Date: Jun. 24, 2004

(54) Apparatus and method for ID-based ring structure by using bilinear pairings

(75) Inventors: Fangguo Zhang, Daejeon (KR); Kwangjo Kim, Daejeon (KR)

Correspondence Address: BACON & THOMAS, PLLC, 625 SLATERS LANE, FOURTH FLOOR, ALEXANDRIA, VA, 22314

(73) Assignee: Information and Communications University Educational Foundation, Seoul (KR)

(21) Appl. No.: 10/671,485

(22) Filed: Sep. 29, 2003

(30) Foreign Application Priority Data
Dec. 24, 2002 (KR) 10-2002-0083113

(51) Int. Cl. H04L 9/00

(52) U.S. Cl. 713/176

(57) ABSTRACT

A cryptosystem employing an identity-based ring signature by using bilinear pairings, which includes a user, a signer and a trusted authority, generates a set of system parameters shared by the user and the signer, generates a public key and a private key for the user and the signer by using the set of system parameters, thereby transmitting the generated public and the private keys to the user and the signer through a secure channel, respectively. The user conceals content of a message, requests a ring signature for the content-concealed message to the signer, and thereafter, verifies validity of the ID-based ring signature. The signer produces the ring signature based on identity (ID) of the user, thereby forming an ID-based ring signature for the content-concealed message.

### FIELD OF THE INVENTION

The present invention relates to a cryptographic system based on a ring signature; and, more particularly, to a system for an identity-based ring signature by using a bilinear pairing.

### BACKGROUND OF THE INVENTION

In a public key cryptosystem, each user has two keys, a private key and a public key. The binding between the public key (PK) and the identity (ID) of a user is obtained via a digital certificate. However, in a certificate-based system, before using the public key of a user, the participant must first verify the certificate of the user. As a consequence, this system requires a large amount of computing time and storage when the number of users increases rapidly.

In 1984 Shamir (A. Shamir, Identity-based cryptosystems and signature schemes, Advances in Cryptology-Crypto 84, LNCS 196, pp.47-53, Springer-Verlag, 1984) suggested ID-based encryption and signature schemes to simplify key management procedures in a certificate-based public key cryptosystem. Since then, many ID-based encryption schemes and signature schemes have been proposed.

Bilinear pairings, namely the Weil pairing and the Tate pairing of algebraic curves, are important tools for research on algebraic geometry. The early applications of the bilinear pairings in cryptography were used to evaluate a discrete logarithm problem. For example the MOV attack (using Weil pairing) and FR attack (using Tate pairing) reduce the discrete logarithm problem on some elliptic curves or hyperelliptic curves to a discrete logarithm problem in a finite field. However, the bilinear pairings have been found in various applications to cryptography recently. More precisely, they can be used to construct ID-based cryptographic schemes. Many ID-based cryptographic schemes have been proposed by using the bilinear pairings. Examples are Boneh-Franklin's ID-based encryption scheme (D. Boneh and M. Franklin, Identity-based encryption from the Weil pairing, Advances in Cryptology-Crypto 2001, LNCS 2139, pp.213-229, Springer-Verlag, 2001.), Smart's ID-based authentication key agreement protocol (N. P. Smart, Identity-based authenticated key agreement protocol based on Weil pairing, Electron. Lett., Vol.38, No.13, pp.630-632, 2002.), and several ID-based signatures schemes, and the like.

The ID-based public key cryptosystem can be an alternative for a certificate-based public key cryptosystem, especially when efficient key management and moderate security are required. In a public key cryptosystem, verifier's anonymity is protected by means of blind signature, whereas a signer's anonymity is protected by a ring digital signature (simply referred to as a ring signature) or a group digital signature.

The concept of ring signature was introduced by Rivest, Shamir and Tauman (R. L. Rivest, A. Shamir and Y. Tauman, How to leak a secret, Advances in Cryptology-Asiacrypt 2001, LNCS 2248, pp.552-565, Springer-Verlag, 2001). A ring signature is considered to be a simplified group signature that has only users without revocation managers. It protects the anonymity of a signer since a verifier knows that the signature comes from a member of a ring, but doesn't know exactly who the signer is. There is also no way to revoke the anonymity of the signer. The ring signature can support an ad hoc subset formation and in general does not require a special setup. Rivest-Shamir-Tauman's ring signature scheme relies on a general public-key cryptosystem.

A general ring signature system requires a large amount of computing time and storage. An ID-based ring signature system using the bilinear pairings is not yet proposed, while many ID-based cryptographic schemes have been proposed by using the bilinear pairings.

### SUMMARY OF THE INVENTION

It is, therefore, an object of the present invention to provide an apparatus and a method for generating a ring signature based on identity and bilinear pairings, which not only reduces overall computing time and required storage but also simplifies key management procedures.

In accordance with one aspect of the present invention, there is provided a method for generating an identity-based ring signature by using bilinear pairings, in a cryptosystem that includes a user, a signer and a trusted authority, which includes the steps of: (a) at the trusted authority, generating a set of system parameters shared by the user and the signer and storing the set of system parameters in a memory of each of the user and the signer; (b) at the trusted authority, generating a public key and a private key for the user and the signer by using the set of system parameters, thereby transmitting the generated public and the private keys to the user and the signer through a secure channel, respectively; (c) at the user, concealing content of a message and requesting a ring signature for the content-concealed message to the signer; (d) at the signer, producing the ring signature based on identity (ID) of the user, thereby forming an ID-based ring signature for the content-concealed message; and (e) at the user, verifying validity of the ID-based ring signature.

In accordance with another aspect of the present invention, there is an apparatus for an identity-based ring signature using bilinear pairings, including: a trusted authority; a user; and a signer, wherein the apparatus performs the steps of: at the trusted authority, generating a set of system parameters shared by the user and the signer and storing the set of system parameters in a memory of each of the user and the signer; at the trusted authority, generating a public key and a private key for the user and the signer by using the set of system parameters, thereby transmitting the generated public and the private keys to the user and the signer through a secure channel, respectively; at the user, concealing content of a message and requesting a ring signature for the content-concealed message to the signer; at the signer, producing the ring signature based on identity (ID) of the user, thereby forming an ID-based ring signature for the content-concealed message; and at the user, verifying validity of the ID-based ring signature.

### BRIEF DESCRIPTION OF THE DRAWINGS

The above and other objects and features of the present invention will become apparent from the following description of a preferred embodiment given in conjunction with the accompanying drawings, in which:

FIGS. 1A to 1C show schematic block diagrams for describing an ID-based ring signature scheme in accordance with a preferred embodiment of the present invention, respectively; and

FIGS. 2A and 2B represent a flow chart for describing an ID-based ring signature procedure in accordance with a preferred embodiment of the present invention.

### DETAILED DESCRIPTION OF THE PREFERRED EMBODIMENTS

An identity (ID)-based ring digital signature scheme in accordance with the present invention may be viewed as a combination of a ring signature scheme and an ID-based signature scheme. Further, the ID-based ring signature scheme of the present invention uses bilinear pairings.

The ID-based ring signature of the present invention includes following four procedures:

1. Setup: determining system parameters PARAMS and a master key s.

2. Extract: taking the master key s and an identity (ID) of a signer; and generating a private key SID and a public key QID of the signer.

3. Signing: taking the PARAMS, the private key of the signer, a list L and a content-concealed message m; and outputting an ID-based ring signature σ(m) for m, wherein the list L is a set of identities of users.

4. Verification: taking the list L, the content-concealed message m and the ID-based ring signature σ(m); and checking whether the ID-based ring signature σ(m) is valid or not.

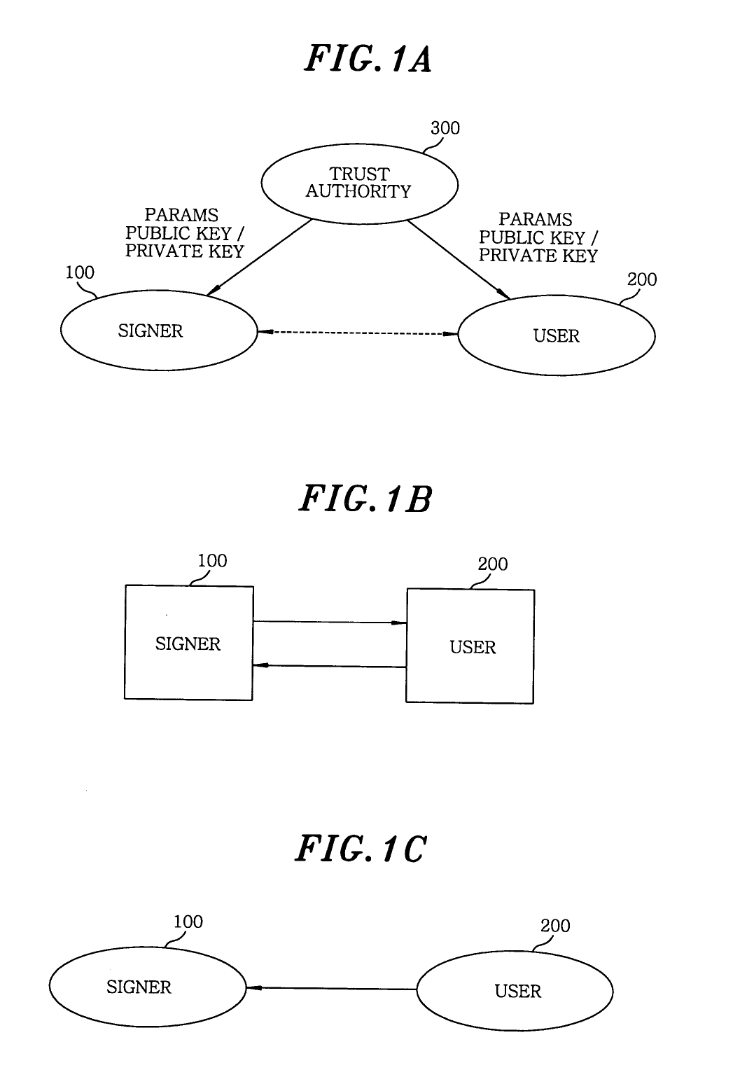

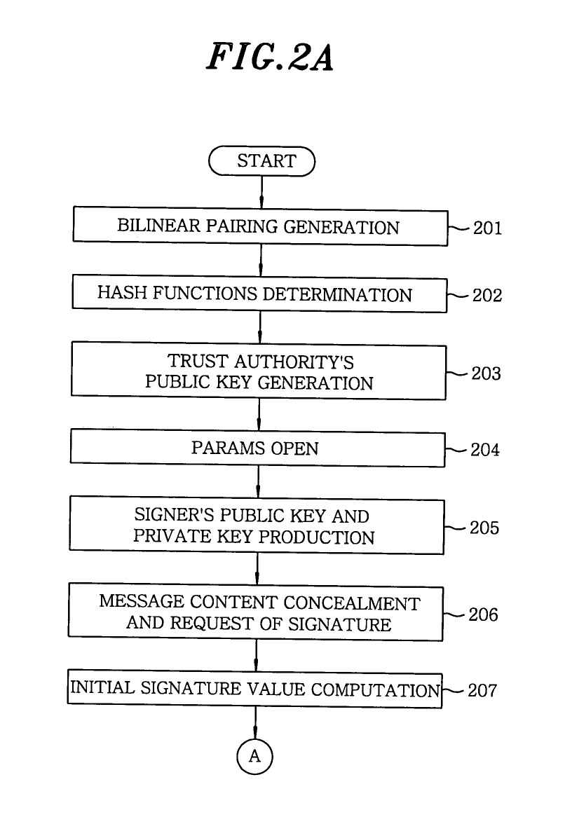

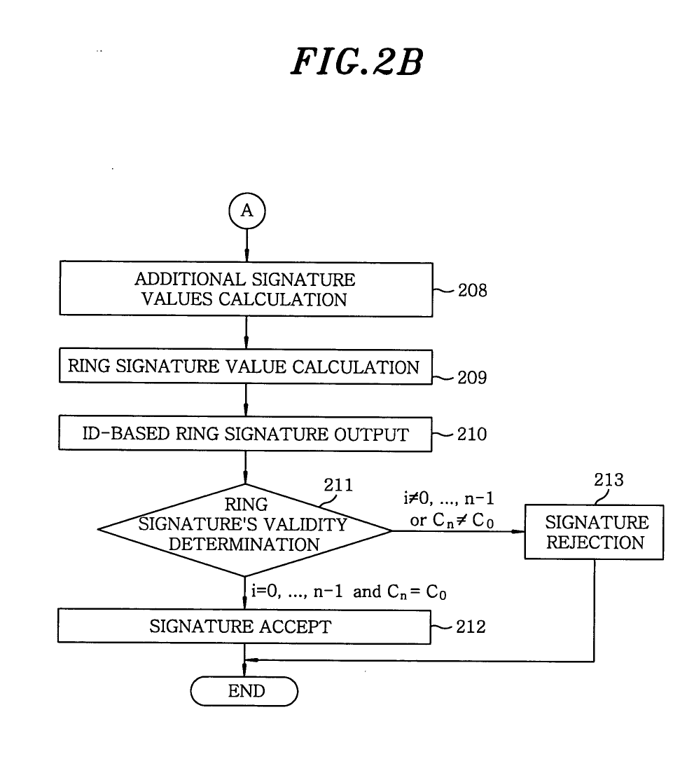

An apparatus and a method based on the above-mentioned ID-based ring signature scheme in accordance with the present invention will be described in detail with reference to FIGS. 1A to 2B.

A signer 100, a user 200 and a trusted authority 300 act as participants of the ID-based ring signature scheme. Herein, each of the participants may be a computer system and they communicate remotely through any kind of communications network or other techniques. Information to be transferred between the participants may be stored and/or detained in various types of storage media.

FIG. 1A shows a schematic block diagram for describing Setup and Extract procedures of an ID-based ring signature system in accordance with the present invention.

The trusted authority 300 generates system parameters (PARAMS) to be utilized by the signer 100 and the user 200, and selects a master key. Further, the trusted authority 300 produces a public key and a private key of each of the signer 100 and user 200 based on identities of the signer 100 and the user 200, and thereafter, provides the keys to the signer 100 and the user 200 through secure channels. The trusted authority 300 participates in the Setup and Extract procedures, but does not participate in subsequent procedures anymore.

FIG. 1B depicts a schematic block diagram for describing a Signing procedure of the ID-based ring signature system in accordance with the present invention.

First, the user 200 conceals content of a message and provides the content-concealed message to one of signers to request a digital signature (more specifically, an ID-based ring signature) for the message.

If the signer 100 receives the request of the signature and the content-concealed message, the signer 100 generates an ID-based ring signature for the content-concealed message without knowing the content of the content-concealed message, based on the PARAMS, by using its own private key.

Referring to FIG. 1C, the user 200 verifies whether the ID-based ring signature provided from the signer 100 is valid or not by using n+1 signature values, the content-concealed message, the PARAMS, the list L and the public key of the signer 100.

A method for the ID-based ring signature in accordance with the present invention will be described in detail with reference to a flow chart shown in FIGS. 2A and 2B. In FIGS. 2A and 2B, it is assumed that the number of the users participating in the ID-based ring signature scheme is “n” and a content-concealed message to be signed is transferred or stored in a digital form.

At step 201, two cyclic groups G and v, whose orders are equal to “q”, are introduced.

To be more specific, a generator P is chosen to introduce the cyclic group G and the other cyclic group V is subsequently introduced by a bilinear pairing “e”, wherein the cyclic group G is an elliptic or hyper-elliptic curves Jacobian and the cyclic group V is a cyclic multiplicative group conventionally corresponding to Z_{q}*. The bilinear pairing “e” from the cyclic group G to the cyclic multiplicative group V is given as follows:

e: G×G→V.

At step 202, cryptographic hash functions H and H₁ are determined as follows:

H: {0,1}*→Z_{q}* and H₁: {0,1}*→G.

At step 203, a random number “s” is chosen as a master key, “s” being an element of Z_{q}*, and a public key P_{pub} of the trusted authority 300 is generated, by the master key s and the generator P of the cyclic group G, as follows:

P_{pub}=s·P.

The public key P_{pub} of the trusted authority 300 may be established before or simultaneously with the determination of the cryptographic hash functions H and H₁.

At step 204, a set of system parameters (PARAMS) {G, q, P, P_{pub}, H, H₁} is opened and shared by the signer 100 and the user 200, to be stored in each memory thereof.

At step 205, a public and a private key of each of the signer 100 and the user 200 are produced at the trusted authority 300. If, for example, the user 200 has an identity IDᵢ, a public key Q_{IDi} and a private key S_{IDi} of the user 200 of IDᵢ are produced as follows:

Q_{IDi}=H₁(IDᵢ) and S_{IDi}=s·Q_{IDi}

wherein “i” is an integer from 1 to n as a user index.

The public Q_{IDi} and the private key S_{IDi} are transmitted through a secure channel and stored in a memory of the user 200 of the IDᵢ.

Subsequently, Signing procedure is carried out.

At step 206, the user 200 content of a message to request a signature (more exactly, ID-based ring signature) for the content-concealed message to a signer.

At step 207, after receiving the content-concealed message and the request of the ID-based ring signature for the content-concealed message from the user 200, the signer 100 takes an ID list L and extracts a random element A from the cyclic group G to thereby compute an initial signature value Cₖ₊₁ as follows:

cₖ₊₁=H(L∥m∥e(A, P)),

wherein “m” is the content-concealed message to be signed and the ID list L is a set of identities of users (i.e., L={IDᵢ}).

Then the initial signature value cₖ₊₁ is stored in a memory of the signer 100.

At step 208, “Tᵢ” is randomly chosen from the cyclic group G, thereby computing and storing in a memory of the signer 100 an additional signature value cᵢ₊₁ as follows:

cᵢ₊₁=H(L∥m∥e(Tᵢ, P)e(cᵢH₁(IDᵢ), P_{pub})),

wherein “i” corresponds to k+1, . . . , n−1, 0, 1, k−1 (i.e., one of values of all modulo n).

At step 209, a ring signature value Tk is computed as follows:

Tₖ=A−cₖS_{IDk},

wherein S_{IDk} is a private key of the signer 100 made at step 205.

The ring signature value Tₖ is stored in a memory of the signer 100.

At step 210, zero is selected as a glue value (i.e.,

n) of the additional signature value to thereby form a ring of ring signature values and then an ID-based ring signature of n+1 ring signature values for the content-concealed message m is obtained in a following sequence (c₀, T₀, T₁, . . . , Tₙ₋₁).

Then the ID-based ring signature is forwarded to and stored in a memory of the user 200

Finally, Verification procedure is carried out.

At step 211, it is determined by the user 200 whether the ID-based ring signature is valid or not based on the following Equation

cᵢ₊₁=H(L∥m∥e(Tᵢ, P)e(cᵢH₁(IDᵢ), P_{pub})).

More specifically, a signature value sequence {cᵢ} can be obtained as follows:

$$\begin{matrix}{c}_{k + 1} = & H ( L ‖ m ‖ e ( A , P ) ) \\ {c}_{k + 2} = & H ( L ‖ m ‖ \begin{matrix}e ( {T}_{k + 1} , P ) & e ( {c}_{k + 1} {H}_{1} ( {ID}_{k + 1} ) , {P}_{pub} ) )\end{matrix} \\ ⋮ & ⋮ \\ {c}_{n} = & H ( L ‖ m ‖ \begin{matrix}e ( {T}_{n - 1} , P ) & e ( {c}_{n - 1} {H}_{1} ( {ID}_{n - 1} ) , {P}_{pub} ) )\end{matrix} \\ {c}_{1} = & H ( L ‖ m ‖ \begin{matrix}e ( {T}_{0} , P ) & e ( {c}_{0} {H}_{1} ( {ID}_{0} ) , {P}_{pub} ) )\end{matrix} \\ {c}_{2} = & H ( L ‖ m ‖ \begin{matrix}e ( {T}_{1} , P ) & e ( {c}_{1} {H}_{1} ( {ID}_{1} ) , {P}_{pub} ) )\end{matrix} \\ ⋮ & ⋮ \\ {c}_{k} = & H ( L ‖ m ‖ \begin{matrix}e ( {T}_{k - 1} , P ) & e ( {c}_{k - 1} {H}_{1} ( {ID}_{k - 1} ) , {P}_{pub} ) )\end{matrix}\end{matrix}$$

wherein i=0, 1, . . . , n−1.

The obtained signature value sequence {cᵢ} is stored in a memory of the user 200.

Meanwhile, in the signing procedure, the initial signature value cₖ₊₁ can be calculated as follows:

$$\begin{matrix}{c}_{k + 1} = H ( L ‖ m ‖ e ( {T}_{k} , P ) e ( {c}_{k} {H}_{1} ( {ID}_{i} ) , {P}_{pub} ) ) \\ = H ( L ‖ m ‖ e ( A - {c}_{k} {S}_{IDk} , P ) e ( {c}_{k} {H}_{1} ( {ID}_{i} ) , {P}_{pub} ) ) \\ = H ( L ‖ m ‖ e ( A , P ) e ( - {c}_{k} {S}_{IDk} , P ) e ( {c}_{k} {H}_{1} ( {ID}_{i} ) , {P}_{pub} ) ) \\ = H ( L ‖ m ‖ e ( A , P ) e ( - {c}_{k} {H}_{1} ( {ID}_{i} ) + {c}_{k} {H}_{1} ( {ID}_{i} ) , {P}_{pub} ) ) \\ = H ( L ‖ m ‖ e ( A , P ) )\end{matrix}$$

In order that the signature is valid, the glue value should be zero (i.e., cₙ=c₀) since the signature value sequence {cᵢ} in the Verification procedure is the same as the Signing procedure. Accordingly, if i=0, 1, . . . , n−1 and cₙ=c₀, then the ID-based ring signature is accepted to be valid at step 212; and if otherwise, the ID-based ring signature is rejected at step 213.

As a conclusion, the ID-based ring signature in accordance with the present invention exhibits properties as followings.

I. Correctness

The signature value sequence {cᵢ} in the Verification procedure should be the same as that in the Signing procedure. Accordingly, it can be verified whether the generated ID-based ring signature is valid or not.

II. Security

The ID-based ring signature holds unconditionally signer-ambiguity, because all Tᵢ but Tₖ are taken randomly from G. In fact, the Tₖ is also distributed uniformly over G, since A is randomly chosen from G. Therefore, |G|ⁿ solutions, all of which can be chosen by the Signing procedure with equal probability, for fixed L and m, (T₀, T₁, . . . , Tₙ₋₁) exist regardless of a signer.

Further, the ID-based ring signature of the present invention is considered to be non-forgeable since the probability of the following c₀ is 1/q.

C₀=H(L∥m∥e(Tₙ₋₁, P)e(cₙ₋₁H₁(IDₙ₋₁), P_{pub}))

III. Efficiency

The ID-based ring signature scheme in accordance with the present invention can be performed with elliptic curves or hyper-elliptic curves, and employs a bilinear pairing. Furthermore, the length of signature can be reduced by a factor of 2 by using compression technique.

Since the ID-based ring signature is based on identity rather than an arbitrary number, a public key has some aspects of user's information, which may uniquely identify the user, such as email address. In some applications, the lengths of public keys and signatures can be also reduced because the length of signature can be reduced.

While the invention has been shown and described with respect to the preferred embodiments, it will be understood by those skilled in the art that various changes and modifications may be made without departing from the spirit and scope of the invention as defined in the following claims.

What is claimed is:

1. A method for generating an identity-based ring signature by using bilinear pairings, in a cryptosystem that includes a user, a signer and a trusted authority, which comprises the steps of:
(a) at the trusted authority, generating a set of system parameters shared by the user and the signer and storing the set of system parameters in a memory of each of the user and the signer;
(b) at the trusted authority, generating a public key and a private key for the user and the signer by using the set of system parameters, thereby transmitting the generated public and the private keys to the user and the signer through a secure channel, respectively;
(c) at the user, concealing content of a message and requesting a ring signature for the content-concealed message to the signer;
(d) at the signer, producing the ring signature based on identity (ID) of the user, thereby forming an ID-based ring signature for the content-concealed message; and
(e) at the user, verifying validity of the ID-based ring signature.

2. The method of claim 1, wherein the step (a) includes the steps of:
(a1) introducing a cyclic group G of an order q by means of a generator P, wherein the cyclic group G is an elliptic or hyper-elliptic curve Jacobian;
(a2) producing a multiplicative cyclic group V of the order q by using a bilinear pairing e expressed as the following Equation:
e: G×G→V
(a3) determining cryptographic hash functions
H: [0,1]*→Z_{q}* and H₁: {0,1}*→G;
wherein Z_{q}* is a multiplicative cyclic group corresponding to V; and
(a4) selecting a master key s of the trusted authority and preparing a public key P_{pub} of the trusted authority by using the master key s and the generator P by using the following Equation
P_{pub}=s·P.

3. The method of claim 2, wherein the set of system parameters has G, q, P_{pub}, P, H and H₁.

4. The method of claim 3, wherein the public key Q_{IDi} and the private key S_{IDi} of the user are stored in a memory of the user, which are defined by using the following Equations:
Q_{IDi}=H₁(IDᵢ) and S_{IDi}=s·Q_{IDi}
where IDᵢ is the user's identity, i being a user index which is an integer ranging from 1 to n.

5. The method of claim 4, wherein the step (d) includes the steps of:
(d1) selecting an ID list L, wherein L is a set of identities of users;
(d2) extracting a random element A of the cyclic group G, thereby computing an initial signature value by using the ID list L;
(d3) choosing a random value of the cyclic group, thereby computing additional signature values by using the ID list L;
(d4) generating a ring signature value by using the private key of the signer;
(d5) forming a ring of ring signature values by selecting zero as a glue value of the additional signature values; and
(d6) storing in a memory of the user the ID-based ring signature of n+1 ring signature values.

6. The method of claim 5, wherein, at the signer, the initial signature value, cₖ₊₁, is computed by using the following Equation:
cₖ₊₁=H(L∥m∥e(A, P)),
wherein k is a signer index and m is the content-concealed message.

7. The method of claim 6, wherein an additional signature value is computed by using the following Equation:
cᵢ₊₁=H(L∥m∥e(T_{i, P})e(cᵢH₁(IDᵢ), P_{pub}))
for “i” corresponding to one of values of all modulo n (k+1, . . . , n−1, 0, 1 and k−1), and then stored in a memory of the signer wherein Tᵢ is the random value of the cyclic group G.

8. The method of claim 7, wherein the ring signature value, Tₖ, is calculated by using the following Equation:
Tₖ=A−cₖS_{IDk};
and stored in a memory of the signer.

9. The method of claim 8, wherein the ID-based ring signature is a sequence (c₀, T₀, T₁, . . . , Tₙ₋₁), which is stored in a memory of the user.

10. The method of claim 9, wherein the validity of the ID-based ring signature is determined by using the following Equations:
$$\begin{matrix}{c}_{k + 1} = & H ( L ‖ m ‖ e ( A , P ) ) \\ {c}_{k + 2} = & H ( L ‖ m ‖ \begin{matrix}e ( {T}_{k + 1} , P ) & e ( {c}_{k + 1} {H}_{1} ( {ID}_{k + 1} ) , {P}_{pub} ) )\end{matrix} \\ ⋮ & ⋮ \\ {c}_{n} = & H ( L ‖ m ‖ \begin{matrix}e ( {T}_{n - 1} , P ) & e ( {c}_{n - 1} {H}_{1} ( {ID}_{n - 1} ) , {P}_{pub} ) )\end{matrix} \\ {c}_{1} = & H ( L ‖ m ‖ \begin{matrix}e ( {T}_{0} , P ) & e ( {c}_{0} {H}_{1} ( {ID}_{0} ) , {P}_{pub} ) )\end{matrix} \\ {c}_{2} = & H ( L ‖ m ‖ \begin{matrix}e ( {T}_{1} , P ) & e ( {c}_{1} {H}_{1} ( {ID}_{1} ) , {P}_{pub} ) )\end{matrix} \\ ⋮ & ⋮ \\ {c}_{k} = & H ( L ‖ m ‖ \begin{matrix}e ( {T}_{k - 1} , P ) & e ( {c}_{k - 1} {H}_{1} ( {ID}_{k - 1} ) , {P}_{pub} ) )\end{matrix}\end{matrix}$$
wherein if i=0, 1, . . . , n−1 and cₙ=c_{O}, then the ID-based ring signature is determined to be valid; and if otherwise, the ID-based ring signature is rejected.

11. An apparatus for generating an identity-based ring signature by using bilinear pairings, comprising:
a trusted authority;
a user; and
a signer,
wherein the apparatus performs the steps of:
at the trusted authority, generating a set of system parameters shared by the user and the signer and storing the set of system parameters in a memory of each of the user and the signer;
at the trusted authority, generating a public key and a private key for the user and the signer by using the set of system parameters, thereby transmitting the generated public and the private keys to the user and the signer through a secure channel, respectively;
at the user, concealing content of a message and requesting a ring signature for the content-concealed message to the signer;
at the signer, producing the ring signature based on identity (ID) of the user, thereby forming an ID-based ring signature for the content-concealed message; and
at the user, verifying validity of the ID-based ring signature.

12. The apparatus of claim 11, wherein the system parameters includes:
a cyclic group G;
G's order q;
G's generator P;
the trusted authority's public key P_{pub} described by P_{pub}=s·P, where s is the master key; and
hash functions H and H₁ described by H: {0,1}→Z_{q}* and H₁: {0,1}→G, where Z_{q}* is a cyclic multiplicative group, wherein the bilinear pairings e are defined by e: G×G→V, where V is a cyclic multiplicative group of the order q and uses cyclic multiplicative group Z_{q}*,
the user's public key Q_{IDi} is described by Q_{IDi}=H₁(IDᵢ), where IDᵢ is the user's identity, i being a user index which is an integer ranging from 1 to n,
the user's private key S_{IDi} is described by S_{IDi}=s·Q_{IDi},
the initial signature value is computed by cₖ₊₁=H(L∥m∥e(A, P)), where k is a signer index, L is a set of identities of users, m is a content-concealed message to be ring-signed and A is a random element of the cyclic group G,
the additional signature values are generated by cᵢ₊₁=H(L∥m∥e(Tᵢ, P)e(cᵢH₁(IDᵢ), P_{pub})), for “i” corresponding to one of values of all modulo n (k+1, . . . , n−1, 0, 1, k−1), where Tᵢ is a random value of the cyclic group G,
the ID-based ring signature value, Tₖ, is calculated by Tₖ=A−cₖS_{IDk},
the ID-based ring signature is obtained in a form of a sequence (c₀, T₀, T₁, . . . , Tₙ₋₁), and
the validity of the ID-based ring signature is determined by means of the following Equations:
$$\begin{matrix}{c}_{k + 1} = & H ( L ‖ m ‖ e ( A , P ) ) \\ {c}_{k + 2} = & H ( L ‖ m ‖ \begin{matrix}e ( {T}_{k + 1} , P ) & e ( {c}_{k + 1} {H}_{1} ( {ID}_{k + 1} ) , {P}_{pub} ) )\end{matrix} \\ ⋮ & ⋮ \\ {c}_{n} = & H ( L ‖ m ‖ \begin{matrix}e ( {T}_{n - 1} , P ) & e ( {c}_{n - 1} {H}_{1} ( {ID}_{n - 1} ) , {P}_{pub} ) )\end{matrix} \\ {c}_{1} = & H ( L ‖ m ‖ \begin{matrix}e ( {T}_{0} , P ) & e ( {c}_{0} {H}_{1} ( {ID}_{0} ) , {P}_{pub} ) )\end{matrix} \\ {c}_{2} = & H ( L ‖ m ‖ \begin{matrix}e ( {T}_{1} , P ) & e ( {c}_{1} {H}_{1} ( {ID}_{1} ) , {P}_{pub} ) )\end{matrix} \\ ⋮ & ⋮ \\ {c}_{k} = & H ( L ‖ m ‖ \begin{matrix}e ( {T}_{k - 1} , P ) & e ( {c}_{k - 1} {H}_{1} ( {ID}_{k - 1} ) , {P}_{pub} ) )\end{matrix}\end{matrix}$$
wherein if i=0, 1, . . . , n−1 and cₙ=c₀, then the ID-based ring signature is accepted to be valid; and if otherwise, the ID-based ring signature is rejected.
